(19) United States
(12) Patent Application Publication
(10) Pub. No.: US 2009/0234770 A1
(43) Pub. Date: Sep. 17, 2009

(54) VEHICLE DISABLEMENT SYSTEM USER INTERFACE

(75) Inventor: Michael P. Simon, Hemet, CA (US)

Correspondence Address: CROWELL & MORING LLP;INTELLECTUAL PROPERTY GROUP, P.O. BOX 14300, WASHINGTON, DC, 20044-4300, US

(73) Assignee: Payment Protection Systems, Inc., Temecula, CA (US)

(21) Appl. No.: 12/048,949

(22) Filed: Mar. 14, 2008

(51) Int. Cl. B60R 25/04

(52) U.S. Cl. 705/40

(57) ABSTRACT

A user interface for a vehicle disablement system is provided. The user interface provides an indication of an amount of time remaining prior to disablement of the vehicle. The indication can be performed using a light emitting diode (LED) which produces either a red or green light. The indication can also be performed by an LED producing a number of blinks corresponding to the amount of time remaining prior to disablement of the vehicle. Additional LEDs can be provided within a numbered user interface, for example, wherein an LED of a number on the user interface is illuminated corresponding to an amount of time remaining prior to disablement of the vehicle.

### CROSS REFERENCE TO RELATED APPLICATION

This application claims the benefit of U.S. Provisional Application No. 60/511,084, filed Oct. 15, 2003 and U.S. patent application Ser. No. 10/958,450, filed Oct. 6, 2004, which are incorporated herein in their entirety.

### BACKGROUND OF THE INVENTION

1. Field of the Invention

The present invention relates to a vehicle disablement system and a user interface therefor. More particularly, the user interface also provides an indication of the amount of time remaining prior to disablement of the vehicle.

2. Description of the Related Art

Due to the mobile nature of automobiles and other types of vehicles, it can be difficult to encourage reliable loan repayments on the automobile. Typically when an automobile loan is in default a repossession company is sent to recover the vehicle. Some people default on loan repayments believing that it is possible to avoid repossession by hiding the automobile from the repossession company. Various systems have been designed to encourage reliable loan repayments. One particular type of system is disclosed in U.S. Pat. No. 6,195,648 issued on Feb. 27, 2001 to Simon et al., the entire contents of which are herein expressly incorporated by reference. The system disclosed by Simon et al. employs a vehicle disablement device to encourage reliable loan repayments. Specifically, the vehicle disablement device of Simon et al. disables a vehicle if a particular code is not entered into the vehicle disablement device prior to a payment due deadline. In order to receive a code, timely payment must be received and logged in a payment center. This type of system encourages reliable loan repayment because the vehicle will be disabled if timely payment is not made.

Systems for encouraging reliable loan repayment have typically been designed for the convenience of the lender with little regard for the consumer using the system. For example, one prior system required the consumer to bring the vehicle back to the lender, or the lender's authorized agent, each time a payment is made in order to have the vehicle disablement device reset. Although this arrangement is convenient for the lender, it is particularly inconvenient for the consumer who must make time to travel to a payment center in order to have the vehicle disablement device reset. The above-mentioned Simon et al. patent addresses this inconvenience by allowing the input of codes to prevent disablement of the vehicle, thereby virtually eliminating the need for the consumer to return with the vehicle to a payment center. However, the design of many systems does not account for the consumer.

### SUMMARY OF THE INVENTION

The above-identified and other deficiencies of prior methods and systems are overcome by the system and methods of the present invention. Specifically, a user interface with time remaining indicators are provided to indicate an amount of time remaining prior to disablement of the vehicle. The time remaining indicators can include light emitting diodes (LEDs) and/or audible warnings. One LED can produce a green light when payments are current and a red light when a payment due date is approaching. This LED can also blink to indicate an amount of time remaining prior to disablement of the vehicle. LEDs can be provided in each of the buttons of the user interface, the LEDs are controlled to illuminate based on an amount of time remaining prior to disablement of the vehicle.

### BRIEF DESCRIPTION OF THE FIGURES OF THE DRAWING

These and other features, aspects, and advantages of the present invention will become better understood with regard to the following description, appended claims and drawings where:

FIG. 1 illustrates a vehicle disablement system user interface; and

FIG. 2 illustrates a block diagram of the user interface and circuitry for controlling the user interface.

### DETAILED DESCRIPTION OF THE PREFERRED EMBODIMENTS

Provided by the present invention is a user interface for a vehicle disablement system which graphically displays time remaining before payment due or disablement or both via buttons and lighting, which interface may also include audible signals. The indication may be performed by buttons backlit with LEDs providing both illumination and flashing, or constant indication of a pending due date. A plurality of buttons may be used, with the LEDs providing light in a number of various ways. For example, the LEDs can provide a steady glow as backlighting, they can blink, they can blink as a brighter flash than backlight, returning to backlighting in between the blinks, or blink from full on to full off, disrupting normal backlighting only on that particular button, or blink with a meaningful sequence. The meaningful sequence can involve flashes in sequences of three, for example, when three days remain, or the number 3 can be seen flashing. Overall, the user interface for the vehicle disablement system of the present invention encourages reliable loan repayment by the consumer by providing effective reminders.

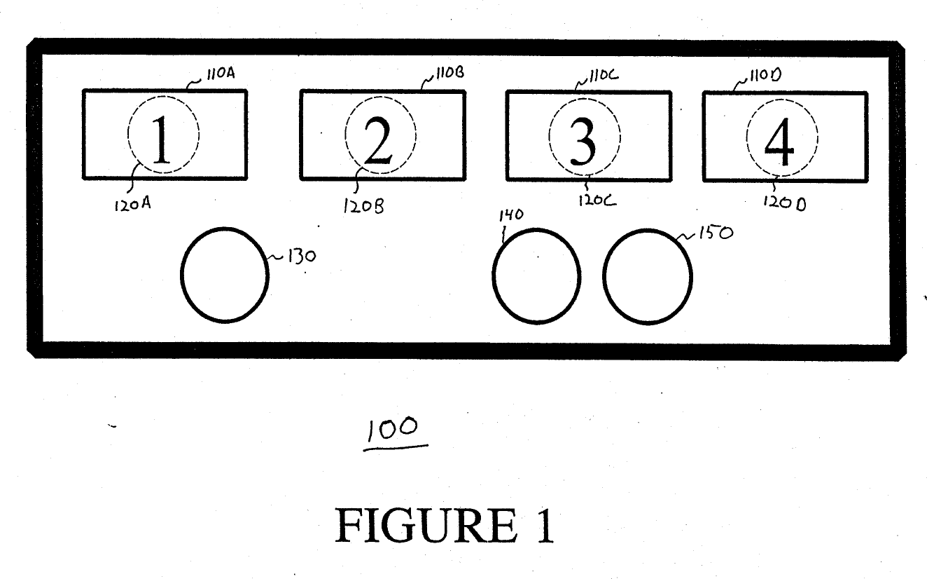

Turning now to the figures of the drawing, FIG. 1 illustrates a vehicle disablement system user interface 100. The user interface 100 includes buttons 110A-110D. Behind the exterior of each of the buttons 110A-110D is a corresponding light emitting diode (LED) 120A-120D. Accordingly, the material comprising buttons 110A-110D is selected such that the illumination from LEDs 120A-120D can be seen through the front exterior of the buttons. Buttons 110A-110D are employed for entering a code which is received in response to providing payment on the loan, wherein the entering of an appropriate code prevents disablement of the vehicle. Although only four buttons are illustrated in FIG. 1, the system can have more or less buttons, depending upon the complexity of the codes and the amount of time it is desired to use the buttons to indicate.

The user interface also includes LEDs 130-150. LED 130 is a component of the time remaining indicator and LEDs 140 and 150 are components of a communication interface. The vehicle disablement user interface 100 can be connected to a vehicle disablement device, or the vehicle disablement user interface 100 can be included in the same enclosure as a vehicle disablement device. In the latter case the user interface 100 will be connected, either directly or indirectly, to a system of the vehicle which is to be disabled if a code is not entered into the vehicle disablement system prior to a payment due deadline.

As discussed above, conventional vehicle disablement systems were designed with little regard to the consumer. Accordingly, the user interface of these devices were typically very basic. One component of the user interface which would increase the ease of use for a consumer, and encourage timely loan repayments, is an indicator of the amount of time, e.g., a number of days, remaining prior to the disablement of the vehicle. Specifically, a consumer may lose track of when a payment is due, and therefore, a mechanism for indicating the amount of time remaining will encourage the consumer to make the loan payment.

Accordingly, LED 130 produces a green light for most of a payment period, the payment period being constrained by a payment due deadline. When the end of the payment period is near, e.g., during the last four days of the payment period, the LED 130 produces a red light indicating that the payment due deadline is approaching. If there is a grace period following the payment period the LED 130 can produce a red light upon initiation of the grace period. Moreover, the LED 130 can produce a number of “blinks” corresponding to the number of days left prior to disablement of the vehicle. For example, if there are three days left prior to disablement of the vehicle, LED 130 will blink three times, pause, and then repeat the three blinks.

The blinking of LED 130, although helpful to many consumers, may be confusing to others. For example, a consumer may miss one of the three blinks and believe that there are only two days left prior to disablement of the vehicle. Moreover, a consumer may not be able to distinguish the three blinks and a pause from a subsequent three blinks, and therefore, incorrectly believe that there are six days left prior to disablement of the vehicle. Accordingly, user interface 100 provides a second mechanism for alerting a consumer of the amount of time left prior to disablement of the vehicle. The second mechanism is LEDs 120A-120D. Accordingly, when there is, for example, three days left prior to disablement of the vehicle, LED 120C will light up. When LED 120C lights up the button 110C will also illuminate, thereby indicating to the consumer that there are three days left prior to disablement of the vehicle.

The lighting up of LED 120C encompasses many embodiments. For example, the LED can provide a continuous dull glow (about 10% of full brightness), thereby providing a backlighting of the keys. An indicating can thereby be a flashing (dull to bright to dull glow) or a steady bright glow (from the dull glow). Thus, the LEDs can be used in many different ways.

LEDs 140 and 150 comprise a communication interface. These LEDs, in conjunction with appropriate electronic circuitry, provide for communication between the vehicle disablement system and an external apparatus. Specifically, LEDs 140 and 150 allow the downloading of information stored in the vehicle disablement system such as current due date, number of payments made, and the like, to an external apparatus such as a personal computer or personal digital assistant (PDA). Furthermore, LEDs 140 and 150 allow the uploading of information from an external apparatus to the vehicle disablement system. The uploading of information can be used for initial programming of the vehicle disablement system, such as number of payment due dates, codes which correspond to payment due dates, and the like. It can also be used for remote entry of key sequences or codes. In accordance with an exemplary embodiment the LEDs 140 and 150 communicate in accordance with the Infrared Data Association (IrDA) communication protocol. If the IrDA communication protocol is employed one of the LEDs 140 and 150 is used for receiving data from an external apparatus, while the other LED is used for transmitting data to the external apparatus. In general, the LEDs 140 and 150 can communicate with any IrDA compatible device.

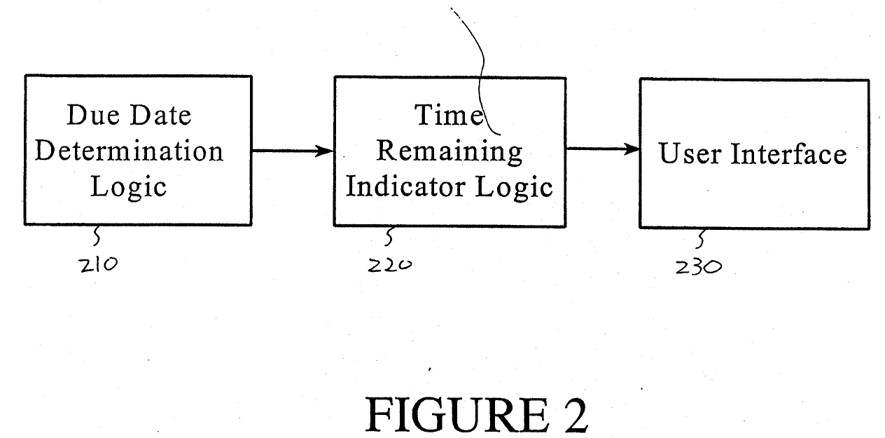

FIG. 2 illustrates a block diagram of a user interface and exemplary circuitry for controlling the time remaining indicators of the user interface illustrated in FIG. 1. The circuitry includes due date determination logic 210 and time remaining indicator logic 220 for controlling user interface 230. The due date determination logic 210 determines when the end of a payment period is approaching, and provides an indication of the amount of time remaining prior to disablement of the vehicle to the time remaining indicator logic 220. Time remaining indicator logic 220 uses the information received from the due date determination logic 210 to control the user interface 230. For example, if the due date determination logic 210 indicates that there are four days left prior to disablement of the vehicle, the time remaining indicator logic 220 will control the user interface 230 such that LED 130 turns red and issues four blinks followed by a pause, and a repetition of the four blinks. The time remaining indicator logic 220 will also control the user interface 230 such that LED 120D illuminates, thereby illuminating button 110D. Disabling circuit(s) may also be appropriately in connection with the user interface.

Although FIG. 2 illustrates the due date determination logic 210 and the time remaining indicator logic 220 as separate elements, these can be combined into a single logic circuit. For example, the functions described above in connection with the due date determination logic 210 and the time remaining indicator logic 220 can be performed by a microprocessor with instructions from memory or a memory device.

Although not explicitly described above, the vehicle disablement system can perform the following steps in connection with the time remaining indicator: comparing the code received from the user with codes stored in memory, which comparison need not be a literal match, but an analytical match, e.g., employing an algorithm; and if there is a match, storing an indication in the vehicle disablement device that the code has been entered, thereby allowing the user to operate the equipment associated with the vehicle disablement device until the date and/or time associated with a code which has not been entered has occurred.

Further, although LED 130 is described as a single LED which can produce a red or green light, multiple LEDs can be used. For example, one LED can produce a green light to indicate that no payment is due, another LED can produce a yellow light to indicate that a payment is due shortly, and a third LED can produce a red light to indicate that the disablement of the vehicle is imminent. In addition to the use of lights to indicate whether a payment is upcoming or due, an audible beep or other sound can be used to indicate such. For example, a single beep can be used to indicate that a payment is upcoming and a constant beep can indicate that a payment is past due.

Although exemplary embodiments of the present invention have been described in connection with particular types of vehicle disablement devices, it will be recognized that the present invention is equally applicable to any type of vehicle disablement devices. Further, although exemplary embodiments of the present invention have been described in connection with a vehicle disablement device, it will be recognized that the present invention is equally applicable to any type of disablement device. Moreover, although the present invention has been described in connection with a loan, the present invention is applicable to any type of third party interest in a vehicle, including, for example, leases.

Although the present invention has been described in considerable detail with clear and concise language and with reference to certain exemplary embodiments thereof including the best mode anticipated by the inventors, other versions are possible. Therefore, the spirit and scope of the invention should not be limited by the description of the exemplary embodiments contained therein.

1-7. (canceled)

8. A vehicle disablement system comprising:
a vehicle disablement device which disables a vehicle if a code is not received by the system prior to a payment due deadline; and
a user interface, the user interface comprising:
a plurality of numbered buttons for inputting the code into the system, and with at least one of the plurality of buttons illuminated with a number corresponding to the remaining number of days prior to disablement of the vehicle.

9. The vehicle disablement system of claim 8, wherein the numbered buttons are illuminated with a light emitting diode.

10. The vehicle disablement system of claim 8, wherein the code input via the user interface is compared to codes corresponding to payment due dates stored in a memory to prevent disablement of the vehicle.

11. The vehicle disablement system of claim 8, wherein the system further comprises a communication interface, with the communication interface receiving information wirelessly from an external device.

12. The vehicle disablement system of claim 11, wherein the information received by the communication interface is used for initial programming of the vehicle disablement system.

13. The vehicle disablement system of claim 8, wherein the vehicle disablement device and the user interface are comprised within a single enclosure.

14. The vehicle disablement system of claim 8, wherein the vehicle disablement device and the user interface are comprised within separate enclosures.

15. The vehicle disablement system of claim 8, further comprising another indicator which is comprised of a light emitting diode which produces a green light when payments are current and a red light when a payment due date is within a predetermined number of days.

16. The vehicle disablement system of claim 15, wherein the red light blinks corresponding to the number of days prior to disablement of the vehicle.
